(19) United States
(12) Patent Application Publication
(10) Pub. No.: US 2012/0169057 A1
(43) Pub. Date: Jul. 5, 2012

(54) WATER POWER GENERATORS

(75) Inventor: Mark Christopher Tonkin, Sussex (GB)

(73) Assignee: DESIGN TECHNOLOGY & INNOVATION LIMITED, London (GB)

(21) Appl. No.: 13/380,297

(22) PCT Filed: Jun. 24, 2010
(86) PCT No.: PCT/GB2010/001258

§ 371 Date: Mar. 19, 2012

(30) Foreign Application Priority Data
Jun. 24, 2009 (GB) 0910867.1

(51) Int. Cl. F03B 13/10; F03B 17/06

(52) U.S. Cl. 290/54

(57) ABSTRACT

An apparatus (2) for placement on or in a body of flowing water (8) for generating hydroelectric power. The apparatus comprises a generally horizontal rotor (6) driven by the water flowing (14) past it to generate electrical power. A method of generating hydroelectric power. The method comprises placing an apparatus in or on a body of water and allowing water to flow past a generally horizontally disposed rotor to turn it and generate electrical power.

This invention relates to hydroelectric power generators.

Extracting power from flowing water has been performed for centuries, originally using water wheels which generated mechanical power that was used to drive mills and machinery. More recently, electricity has been generated using the power from flowing water. Typically this is done by creating a head of water, e.g. by damming a river, and then allowing the water to fall through a turbine which the water turns to generate the electricity. Alternatively the flow of water due to tides can be used to drive turbines which are situated in tidal flows, e.g. estuaries.

To generate sufficient power to be economically viable, this type of hydroelectric power generation requires large scale installations which are very expensive and require a suitable geographic location. Moreover it is necessary either to find somewhere with a sufficient natural head of water or more typically to dam the river, which can create damaging environmental consequence& e.g. flooding farmland and adversely affecting fish migration routes. Conventional hydroelectric power generation is not therefore suitable for small bodies of flowing water, especially in remote locations.

When viewed from a first aspect the present invention provides an apparatus for placement on or in a body of flowing water for generating hydroelectric power comprising a generally horizontal rotor adapted to be driven by water flowing past it to generate electrical power.

When viewed from a second aspect the invention provides a method of generating hydroelectric power comprising placing an apparatus in or on a body of water, said apparatus comprising a rotor generally horizontally disposed, and allowing water to flow past the rotor to turn it and generate electrical power.

By providing a hydroelectric power generator in which the rotor is horizontal, the generator can be operated simply by placing it on or in the body of flowing water so the water turns the rotor. A head of water, created for example by a dam, is not necessary. This allows for small and inexpensive installations which makes it ideally suited to small scale electricity generation in remote locations and in bodies of flowing water such as rivers.

Depending upon the characteristics of the water flow in the body of flowing water, the rotor could be driven simply by being exposed to the water natural water flow. In a set of preferred embodiments however the invention comprises means for directing water flow past the rotor. The means for directing the water past the rotor could be a wall or one or more baffles. In a preferred set of embodiments the means for directing water is provided by placing the rotor in a channel. Such a channel acts to protect the rotor and to ensure an efficient transfer of kinetic energy from the water to the rotor. The channel could be cylindrical—i.e. with a constant e.g. circular cross-section, or could for example taper to give a increased local flow velocity past the rotor.

Where provided the means for directing water past the rotor could be fixed in shape or could be adjustable depending upon the flow conditions

The rotor could be mechanically coupled, e.g. via a gearbox, to a generator. In some preferred embodiments however the rotor itself forms part of a generator with one or more suitable corresponding stators provided on the static part of the apparatus to generate electricity through electromagnetic induction. The stator(s) is/are conveniently provided on a wall adjacent the rotor—e.g. a wall of the channel. In this way, the apparatus can be compact and self-contained—e.g. with just an electrical cable coming from it to supply power.

The rotor and the stator can generate the electricity through any of a varied number of known generating methods, e.g. operating it as a synchronous singly-fed generator, an induction singly-fed generator, a doubly-fed generator, etc.

In one set of embodiments the rotor comprises a plurality of discrete blades. The blades could be arranged in one or more circumferential sets, in one or more helical sets, or indeed in any other effective configuration. In another set of embodiments the rotor comprises a continuous surface, also referred to as a screw or Archimedes screw. A continuous Archimedes screw has been found to be best at maximising the power generated from flowing water. In one set of embodiments the Archimedes-screw comprises two or more continuous helical surfaces, wherein the two surfaces are interlaced.

The Applicant has found that the most efficient way of extracting hydroelectric power from a body of flowing water is, counter-intuitively, not to fully submerge the rotor of the generator in water. Accordingly the apparatus is preferably configured such that in use the rotor is not fully submerged. One way of achieving this is to make the apparatus float so that the rotor protrudes partly from the surface of the water. In this case if a channel is provided it could be open at the top or closed at the top so as to cover the rotor. In a set of embodiments the extent of immersion of the rotor is adjustable.

In a preferred set of embodiments the apparatus is designed to be fully submerged. This is particularly advantageous as by having the apparatus under the surface of the water, it can be used in many more places than if it were visible. In such embodiments the advantage obtained by having the rotor partly out of the water can be achieved by having a cover over the rotor configured such that a volume of air (or other gas) is trapped underneath. This will provide a degree of buoyancy although in some embodiments additional buoyancy could be provided by external means, e.g. buoyancy chambers filled with air or expanded polystyrene foam. Such a cover could, of course, be provided by the wall of a channel.

Preferably means are provided to anchor the apparatus, either to the bottom of the body of water, to a side bank, e.g. in a river, or to a suitable stationary or floating object. This enables it to be accurately positioned within a body of flowing water, e.g. to position it at the point of maximum flow, and to remain at the required depth. A suitable object could be, for example, a fixed pile, but in some preferred embodiments it is envisaged that the object could be a floating platform, floating pontoon, boat or barge. Such a floating object could be anchored or tethered in place when the apparatus is in use, but is also able to be towed, or to move under its own power, in order to transport the apparatus to different locations. This would enable the apparatus to be transported to a location which happened to be particularly advantageous with regard to water flow conditions, e.g. the increased seasonal flow a river due to rain or snow melt.

The generator could be used to generate electricity for on-board equipment—for example it could be incorporated into an autonomous weather station or used in an autonomous underwater vehicle (AUV). Preferably means are provided to transport the generated electrical power away from the apparatus, i.e. to an external load.

Certain preferred embodiments of the invention will now be described, by way of example only, with reference to the accompanying drawings in which:

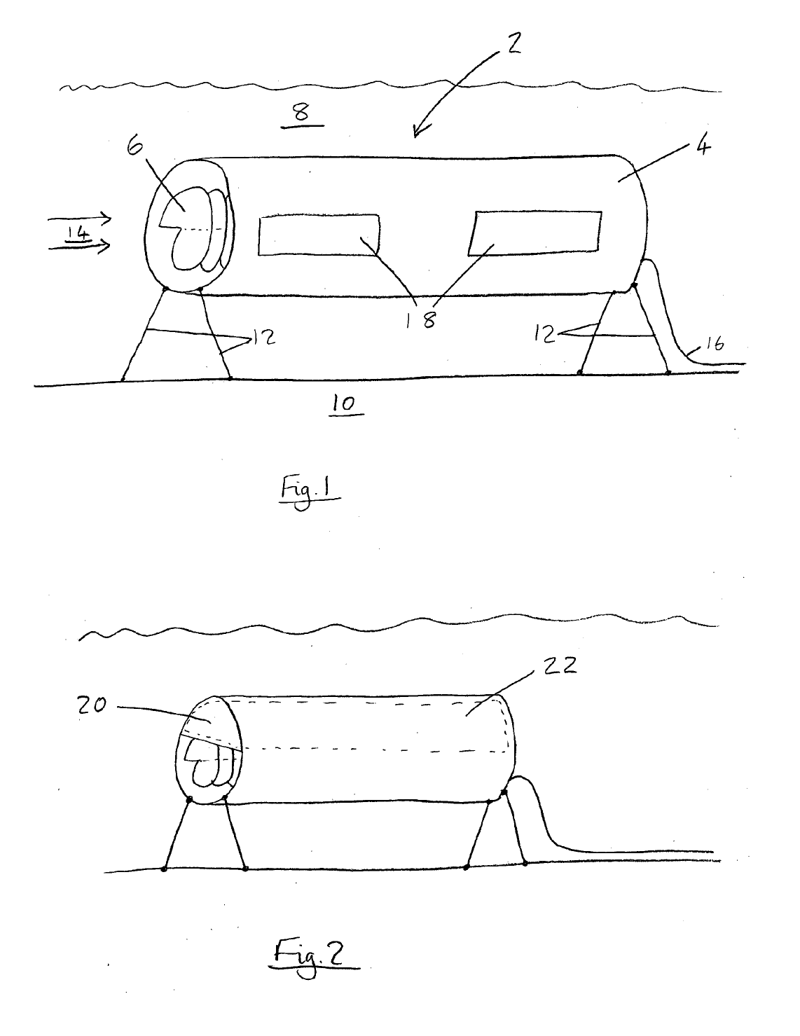

FIG. 1 shows a hydroelectric power generator in accordance with the invention;

FIG. 2 shows an embodiment of the generator with a volume of trapped air within the channel.

FIG. 1 shows a view of a hydroelectric power generator 2 in accordance with the present invention. The generator comprises a cylindrical channel 4 which houses along its longitudinal axis an Archimedes screw 6. The channel 4 is arranged to act as the generator's stator, and the screw 6 is arranged to act as the generator's rotor.

The generator 2 can be located in a body of flowing water such as a river 8 such that the screw 6, and hence the rotor of the generator, is horizontal, and thus has its axis parallel to the flow of the water 14. Buoyancy devices 18 attached to the channel 4 of the generator 2 provide the generator with a predetermined amount of buoyancy. The generator 2 is also anchored to the bottom of the body of water 10 by tethers 12 which are securely attached at both ends to the generator channel 4 and the bottom of the body of water 10 respectively. The buoyancy devices 18 and the tethers 12 act together to position the channel 4 within the body of water 8. The tethers 12 also stop the generator 2 being dragged away by the flow of water 14.

An electricity cable 16 is attached to the generator 2 to transport away electricity generated by the generator 2.

FIG. 2 shows a generator with similar features to that shown in FIG. 1. In this embodiment however, instead of buoyancy devices, a partial cap 20 is placed at either end of the generator channel 4 which traps a volume of air 22 within the channel 4. This gives the generator the required buoyancy as well as creating a an air pocket above the rotor 6.

In operation the generator is positioned by the buoyancy devices 18 or trapped volume of air 22, and the tethers 12 such that the screw 6, i.e. the rotor of the generator, lies horizontally in a body of flowing water 8, with the axis of the rotor parallel to the flow of water 14. In the embodiment shown in FIG. 1, the generator 2 can be positioned such that the channel 4 is either completely or partially submerged in water. In the embodiment shown in FIG. 2, the trapped volume of air 22 ensures that the screw 6 is not completely submerged in water. It has been found that the generator 2 operates more efficiently when the screw 6 is not completely submerged.

The water flows through the channel 4, with the force of the water against the screw 6 driving the rotor of the generator. The rotor therefore rotates inside the stator housed in the channel 4, and electromagnetically induces a current which is drawn off by the electricity cables 16 to power a load.

It will be appreciated by those skilled in the art that only a small number of possible embodiments have been described and that many variations and modifications are possible within the scope of the invention. For example the generator could have variable buoyancy and or tethers to change its position in the body of water. In the alternative embodiment this could be achieved, for example, by having a variable volume of trapped air. The channel is not essential and could be replaced by one or more walls or baffles or simply omitted completely in suitable flow conditions.

1. An apparatus for placement on or in a body of flowing water for generating hydroelectric power comprising a generally horizontal rotor adapted to be driven by water flowing past it to generate electrical power.

2. An apparatus as claimed in claim 1 comprising an arrangement for directing water flow past the rotor.

3. An apparatus as claimed in claim 2 wherein the arrangement for directing water flow past the rotor comprises a channel in which the rotor is placed.

4. An apparatus as claimed in claim 1, wherein the rotor forms part of a generator with one or more corresponding stators provided on the static part of the apparatus to generate electricity through electromagnetic induction.

5. An apparatus as claimed in claim 4 wherein the one or more stators are provided on a wall adjacent the rotor.

6. An apparatus as claimed in claim 1 wherein the rotor comprises a continuous surface.

7. An apparatus as claimed in claim 6 wherein the rotor comprises two or more continuous helical surfaces, wherein the two surfaces are interlaced.

8. An apparatus as claimed in claim 1 wherein the apparatus is configured such that in use the rotor is not fully submerged in the water.

9. An apparatus as claimed in claim 1 wherein the apparatus is arranged to be fully submerged in the water.

10. An apparatus as claimed in claim 8 wherein the apparatus is arranged to be fully submerged in the water, the apparatus further comprising a cover over the rotor configured such that a volume of air is trapped underneath the cover.

11. An apparatus as claimed in claim 1 comprising means to anchor the apparatus.

12. An apparatus as claimed in claim 11 wherein the apparatus is anchored to a floating platform, floating pontoon, boat or barge.

13. An apparatus as claimed in claim 1 comprising a connection to transport the generated electrical power away from the apparatus.

14. A method of generating hydroelectric power comprising placing an apparatus in or on a body of water, said apparatus comprising a rotor generally horizontally disposed, and allowing water to flow past the rotor to turn it and generate electrical power.

15. A method as claimed in claim 14 comprising directing water flow past the rotor.

16. A method as claimed in claim 15 wherein the apparatus comprises a channel in which the rotor is placed.

17. A method as claimed in claim 14, wherein the rotor forms part of a generator with one or more corresponding stators provided on the static part of the apparatus to generate electricity through electromagnetic induction.

18. A method as claimed in claim 17 wherein the one or more stators are provided on a wall adjacent the rotor.

19. A method as claimed in claim 14 wherein the rotor comprises a continuous surface.

20. A method as claimed in claim 19 wherein the rotor comprises two or more continuous helical surfaces, wherein the two surfaces are interlaced.

21. A method as claimed in claim 14 comprising not fully submerging the rotor in the water.

22. A method as claimed in claim 14 comprising fully submerging the apparatus in the water.

23. A method as claimed in claim 14 comprising anchoring the apparatus.

24. A method as claimed in claim 23 comprising anchoring the apparatus to a floating platform, floating pontoon, boat or barge.

25. A method as claimed in claim 14 comprising transporting the generated electrical power away from the apparatus.
